(19) United States
(12) Patent Application Publication
(10) Pub. No.: US 2011/0125543 A1
(43) Pub. Date: May 26, 2011

(54) SUPPLY CHAIN OPTIMIZATION SYSTEM AND METHOD FOR OPTIMIZING SUPPLY CHAIN

(76) Inventors: Makoto Saito, Tokyo (JP); Shinichi Daiba, Tokyo (JP); Mitsuru Nagasaki, Tokyo (JP)

(21) Appl. No.: 13/055,034

(22) PCT Filed: Jun. 26, 2009
(86) PCT No.: PCT/JP2009/061733

§ 371 Date: Jan. 20, 2011

(51) Int. Cl. G06Q 10/00

(52) U.S. Cl. 705/7.22

(57) ABSTRACT

Provided is a supply chain optimization system and a method for optimizing a supply chain that can prevent a production delay due to the lack of materials and a shipment delay due to the lack of stock products even if a sales plan fluctuates on an increase in sales of the supply chain as a whole and that can optimize the stocks of the products and materials and a physical distribution route of product supplies. The supply chain optimization system and the method for optimizing the supply chain calculate through a simulation in which a supply chain model is used so that a total sum of stock costs for products and materials and logistics costs therefor are minimized with respect to the number of stock products and materials which do not cause product defects at a fluctuation time of a sales plan on a condition in which the stock products increased in accordance with the fluctuation of the sales plan are set to factory stocks. Further, number of the stocks, costs for the stocks and logistics costs are set to a KPI of the supply chain to be managed. In addition, a physical distribution route from a factory increased in the stock products is optimized through the simulation.

### FIELD OF THE INVENTION

The present invention relates to optimization of a supply chain including production processes from material procurement to sales, in which, the inventory quantity and the inventory value of products are optimized so that when a change happens in a sales plan, product delivery will not be delayed, and a physical distribution route of the products at the occurrence of the sales plan change is optimized.

### DESCRIPTION OF THE RELATED ART

Delivery of products to a client involves a plurality of operation areas from the procurement of materials (hereinafter, also referred to as parts) to the delivery of products to the client, for example, material procurement, production, sales, etc.; and a series of business activities is achieved through coordination of activities in these operation areas.

The operation area is not necessarily based in one location, but generally has a plurality of bases in many cases. For example, a sales division, which is a sales operation area, often has a plurality of sales bases.

It is important to optimize such series of business activities, or so-called a supply chain; and it's been studied as a major issue.

When optimizing such supply chain having a plurality of operation areas, it is necessary to consider from a plurality of viewpoints, taking into account: production data such as production quantities and delivery dates; the forms of procurement, production, physical distribution, and sales; and base information for these operations. This is generally called supply chain management (SCM).

Consequently, a supply chain model has been created for a simulator to perform a simulation to optimize the supply chain, in the course of developing a method for optimizing the supply chain.

When the supply chain has an operation area insufficiently informed on the flow of goods, for example, if there is an operation having no clear information about an inventory quantity, the supply chain may not function well. Thus, in order to optimize the flow of information and goods in operations from material procurement to client delivery, such as material procurement, production, and sales, the flow of goods must be obtained in real time by all the operations in the supply chain. For this reason, an information system package called an ERP (Enterprise Resource Planning) package has been progressively introduced to the core operations in corporations.

The ERP package is an integrated operation package, which is a software package for a corporate information system, integrating all operations across the corporate activities including sales, production, physical distribution, finance, etc. This package integrates those systems which have been separately built for each division, to allow mutual referencing and usage, and it also allows the unified management of financial accounting and personnel data, simplified system version upgrade and maintenance check, and the real-time referencing of operations in other divisions.

Note that, in the supply chain, sales and production plans are prepared based on a demand (order receiving), and then, materials are procured from outside the company or from another factory (hereinafter, referred to as a supplier) and production activities are performed in production processes accordingly. When procuring the materials, the procuring side (the ordering side) generally informs a supplier about an expected material order in the future (forecast information) for smooth procurement in addition to material purchase order confirmation information. The forecast information will be changed to material purchase order confirmation information on a predetermined date. This allows the supplier to plan future production and to prevent overstocking or inventory shortage.

The demand, however, does not always remain constant, and may cause the sales plan to be changed. For this reason, when the forecast information is changed to the material purchase order confirmation information, the production plan may need to be changed. Consequently, it is expected to accommodate especially a sales plan increase without production delay due to a material shortage and shipment delay due to a product inventory shortage while eliminating the unnecessary stocks of materials and products to minimize the inventory cost.

In response to this, a method is disclosed in which, previous forecast information and corresponding order records are used to calculate errors in the previous forecast information, the average of the errors, and the standard deviation of the errors, and based on which values, current forecast information is corrected to calculate an order quantity (for example, see patent document 1).

In addition, another method is disclosed in which, the addable manufacturing quantity of products is calculated, then based on the resource quantity available in a period needed for additional manufacturing, an additional order quantity calculation means for determining an additional order quantity of the resource in the period calculates an additional order quantity to order parts (for example, see patent document 2).

Yet another method is disclosed in which, management periods are set for a production demand, and an upper limit is set for a short-notice production increase by applying restrictions by cumulative total value control to manage prior material arrangement (forecast information) and production quantity determination (for example, see patent document 3).

### PRIOR ART DOCUMENTS

### Patent Documents

Patent Document 1: Japanese Patent Laid-open No. 2006-39802
Patent Document 2: Japanese Patent Laid-open No. 2006-155361
Patent Document 3: Japanese Patent Laid-open No. 2006-113748

### SUMMARY OF THE INVENTION

### Problems to be Solved by the Invention

In patent document 1, the order quantity is calculated by correcting the current forecast information, allowing the ordered side to estimate the order with high accuracy and to effectively prevent the occurrence of inventory shortage or overstocking. However, when the order is unexpectedly changed, there is no way to estimate an inventory shortage, thus the inventory could run out.

In patent document 2, the additional order quantity calculation means calculates an additional order quantity for ordering parts to reduce unnecessary stocks as much as possible while keeping enough inventories to accommodate a change in product demand. However, it only calculates an additional order quantity, that is, an addable manufacturing quantity so that when the order is unexpectedly changed in a quantity more than the addable manufacturing quantity, the inventory could run out.

In patent document 3, the cumulative total of scheduled production quantities and the cumulative total of arranged part quantities are used to set an upper limit for a short-notice production increase and to manage prior material arrangement (forecast information) and production quantity determination. However, when an increase in production over the upper limit happens, the material inventory could run out.

When a sales plan is changed and production is suddenly increased, requiring material procurement to follow the changed production plan, an ordinary physical distribution route normally used for material procurement may have a problem, depending on the material, in its physical distribution lead time such as the number of hours or days for physical distribution. The physical distribution routes include various types such as sea freight, truck freight, and air freight; and generally in physical distribution, the longer the physical distribution lead time is, the less the physical distribution cost will be, for example, as in sea freight, and the shorter the physical distribution lead time, the more the cost, for example, as in air freight. For this reason, the physical distribution route having a longer physical distribution lead time but less cost, such as sea freight, is usually used. Therefore, when a production plan is changed to increase the production, if materials normally delivered by the physical distribution route having a longer physical distribution lead time are ordered according to the material purchase order confirmation information, they may not arrive before the beginning of the production, possibly causing a product inventory shortage by the delivery date.

Conventionally, such case has been generally managed by setting the material inventory higher to increase the inventory in the production process, or by using another temporary physical distribution route having a shorter physical distribution lead time (such as air freight) to avoid delay in material delivery.

Note that a delivery lead time here is a lead time required from the time of product or material order to a supplier (a material supplier, factory, etc.) to the time of delivery to a predetermined location, and a physical distribution lead time is a lead time required from the time of product or material dispatch by the supplier to the time of delivery to the predetermined location.

When a temporary physical distribution route is used, for example, when sea freight is changed to air freight, the physical distribution lead time will be significantly reduced, but the physical distribution cost will be drastically increased in most cases. For this reason, even though the inventory in the production process is kept minimum, the physical distribution cost is increased significantly depending on the material, so that the total of the inventory cost and the physical distribution cost in the method using the temporary physical distribution route may result in higher than the total inventory cost in the method of increasing the safety inventory quantity because the cost of air freight is high.

The method of increasing the inventory quantity can reduce delays in product delivery. However, a material procurement operation area (hereinafter, also referred to as a material procurement division) will have a safety stock of materials (parts) having a longer delivery lead time, or so-called long-lead items. A production operation area (hereinafter, also referred to as a production division) will have a safety stock of products and partly-finished goods in the process for those products having a longer production lead time. Additionally, a sales operation area (hereinafter, also referred to as a sales division) will have a safety stock of products in case product delivery should delay due to a material shortage in the production division. In this way, since each division in the supply chain will have a separate safety stock according to its own need, the supply chain as a whole will have excessive inventories. The inventory cost will be increased accordingly, and such state will be continued.

FIG. 3 shows a conventional method of managing product stocks. As shown in the figure, product inventories are kept in sales storages and sales bases so that the additional stock of safety product inventories to accommodate a sales plan change is also managed in each sales base. In addition, an ordinary route is used for the physical distribution of products.

Note that the production division is a division within a factory here, and the factory and the production division are said to be synonymous.

As previously described, each of the operation areas often has a plurality of bases in general. In particular, the sales division does not remain in a single country but often has many bases worldwide. Consequently, having a safety product inventory in each sales base on the assumption of a sales plan change will cause an increase in the inventory cost of the entire supply chain since the safety product inventory in the sales division includes stock products with high unit price.

Furthermore, when sales plans are changed in the supply chain, the changes are likely to be different in every sales base. For example, each sales base may have an increase, no change or a decrease in product quantities. Thus, when the sales plan changes are viewed in terms of the entire supply chain, having a safety product inventory in each sales base to similarly accommodate a sales plan change is having redundant safety inventories, or excess inventories, resulting in an excess inventory value.

The present invention is made in consideration of the above situations, and its object is to provide a system and a method for optimizing a supply chain which, when a sales plan is changed to increase a sales quantity in the supply chain, allow the supply chain as a whole to prevent production delay due to a material shortage and shipment delay due to a product inventory shortage, and also optimize the product-and-material inventory and a physical distribution route for supplying products.

### Means for Solving the Problems

The above object can be achieved by the following constitution and method.

1. According to one aspect of the present invention, a supply chain optimization system for optimizing a supply chain made up of a series of multiple operation areas having a plurality of bases for operations from material procurement and product production to sales, in which, materials order information is changed from expected future materials order information (forecast information) to materials order confirmation information, and there may be a change in a production plan due to a product quantity change in a sales plan, includes: a storage means for storing data and information; a model building means for building a supply chain model on a computer, modeling the supply chain; a sales plan creation means for, when a product quantity is changed in a sales plan in the supply chain, creating a changed sales plan and storing the changed sales plan in the storage means; a production plan creation means for creating a changed production plan based on the changed sales plan and storing the changed production plan to the storage means; a data processing means for downloading product information, production information, and physical distribution route information from an ERP (Enterprise Resource Planning) package storing the product information, the production information, and the physical distribution route information, as well as downloading the changed sales plan and the changed production plan from the storage means, generating simulation data based on the product information, the production information, the physical distribution route information, the changed sales plan, and the changed production plan, and storing the data to the storage means; an inventory calculation means for performing a simulation in response of the sales plan change based on the simulation data using the supply chain model, and under the condition that an additional product stock increased by the sales plan change is kept in a factory inventory, calculating a product-and-material inventory quantity which allows no product shortage at the occurrence of the sales plan change while minimizing the total of a product-and-material inventory value and a product-and-material physical distribution cost; and a physical distribution route selection means for selecting a physical distribution route from the factory having the additional product stock.

2. According to another aspect of the present invention, in the supply chain optimization system according to 1, the multiple operation areas include a material procurement operation area, a production operation area, and a sales operation area.

3. According to yet another aspect of the present invention, in the supply chain optimization system according to 1 or 2, the materials include partly-finished products.

4. According to yet another aspect of the present invention, in the supply chain optimization system according to any one of 1 to 3, the product information includes data on materials used for the product, a quantity of the materials, a product flow chart, and a product structure.

5. According to yet another aspect of the present invention, in the supply chain optimization system according to any one of 1 to 4, the production information includes a production quantity of the products; delivery date production plan information; inventory information, order information, delivery information, and price information of the materials; and product inventory information.

6. According to yet another aspect of the present invention, in the supply chain optimization system according to any one of 1 to 5, the physical distribution route information includes the physical distribution lead time and the physical distribution cost of physical distribution routes for the products and the materials.

7. According to yet another aspect of the present invention, in the supply chain optimization system according to any one of 1 to 6, at the time of the simulation, the simulation is performed by downloading information on the bases in the supply chain, communication environment information about the state of communication environment of the bases, and physical distribution information about the state of physical distribution of the bases, stored in the storage means.

8. According to yet another aspect of the present invention, in a supply chain optimization method, the supply chain optimization system according to any one of 1 to 7 is used to calculate the product-and-material inventory quantity including the additional product stock kept in the factory inventory responding to the sales plan change, the product-and-material inventory value, and the product-and-material physical distribution cost to accommodate the sales plan change, and these values are set as a key performance indicator of the supply chain to manage the supply chain.

9. According to yet another aspect of the present invention, in the supply chain optimization method according to 8, the supply chain optimization system is used to select a physical distribution route for the additional product stock to accommodate an actual product quantity change in a sales plan in the supply chain, and the physical distribution route in the supply chain is changed accordingly.

### Effects of the Invention

As described above, the safety inventory for accommodating a sales plan change happened in the supply chain can be optimized not at each individual division level, but at the entire supply chain level to effectively control material and product shortage and overstocking and to minimize the total of the inventory value and the physical distribution cost. Furthermore, the optimum physical distribution route for products can be quickly calculated so that the physical distribution route can be changed to prevent delivery delay.

In addition, suppliers can obtain information on the simulation results from the ERP package to plan future production so that when their production plans need to be changed due to an unexpected sales plan change, overstocking or inventory shortage can be prevented.

### BRIEF DESCRIPTION OF THE DRAWINGS

FIG. 1 shows an example of an embodiment of a supply chain and a supply chain optimization system according to the present invention.

FIG. 2 is a block diagram showing an example of the supply chain optimization system according to the present invention.

FIG. 3 shows a conventional method, illustrating the safety inventory of products and a physical distribution route for the products.

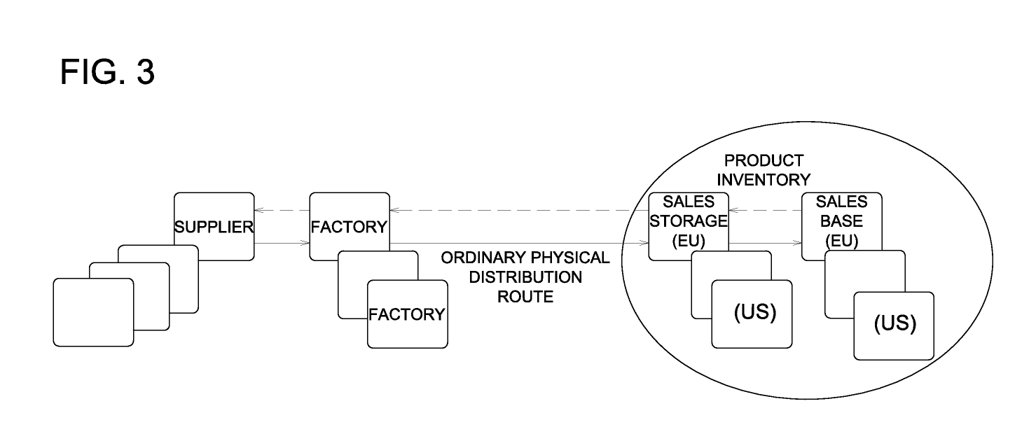

FIG. 4 shows a method according to the present invention, illustrating an additional stock of products and a physical distribution route for the additional stock.

FIG. 5 shows an example of a flowchart of the supply chain optimization system shown in FIG. 2.

FIG. 6 shows an example of a flowchart for optimizing a physical distribution route for products and materials when an actual change in a sales plan happens.

FIG. 7 shows the transition of forecast information and material purchase order confirmation information.

### DETAILED DESCRIPTION OF THE PREFERRED EMBODIMENTS

An embodiment of the present invention will be described below with reference to the accompanying drawings; however, the present invention is not limited thereto.

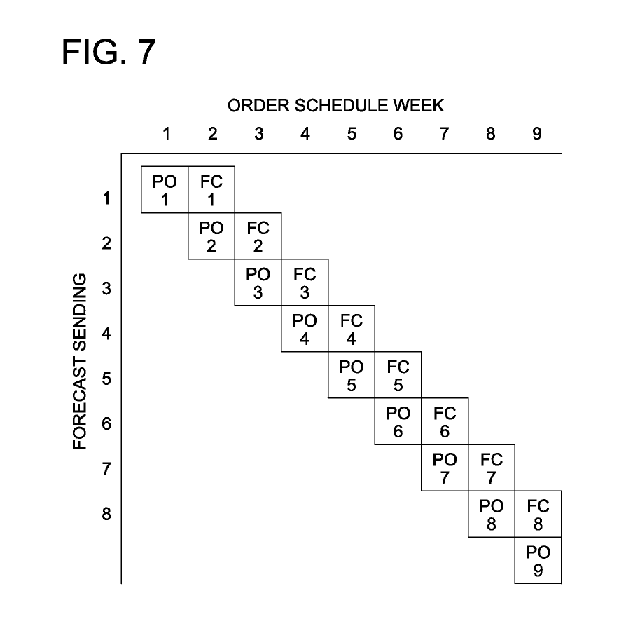

FIG. 7 is a table showing an example of the transition of forecast information (hereinafter, also referred to as a forecast) and material purchase order confirmation information (hereinafter, also referred to as a firm purchase order). In FIG. 7, an ordering interval, a forecast sending interval, and a delivery lead time is one week. These intervals may be appropriately set in accordance with the type of products and materials; for example, they may be two weeks or a month. Each of these intervals may have a different period from the others. In FIG. 7, a firm purchase order is shown as PO and a forecast as FC.

According to a production plan prepared based on an initial order acceptance, a firm purchase order PO1 is placed and a forecast FC1 is sent in order schedule week 1. PO1 is delivered in week 2. In week 2, after FC2 is changed to PO2, PO2 is placed, and at the same time, a forecast FC2 is sent. PO2 is delivered in week 3. The process will go on in the same manner. In the example of FIG. 7, the delivery will be completed in nine weeks.

In the example of FIG. 7, the purchase order is placed after creating a material requirement plan every week through MRP (material requirement planning) based on the production plan.

In addition, further order information such as reservation information (reservation), for example, may be provided between the forecast and the firm purchase order. In this case, for example, the forecast is not a commitment for purchasing materials, the reservation is an assurance for the purchase with no commitment on purchase time, and the firm purchase order is an assurance for both the purchase and the purchase time.

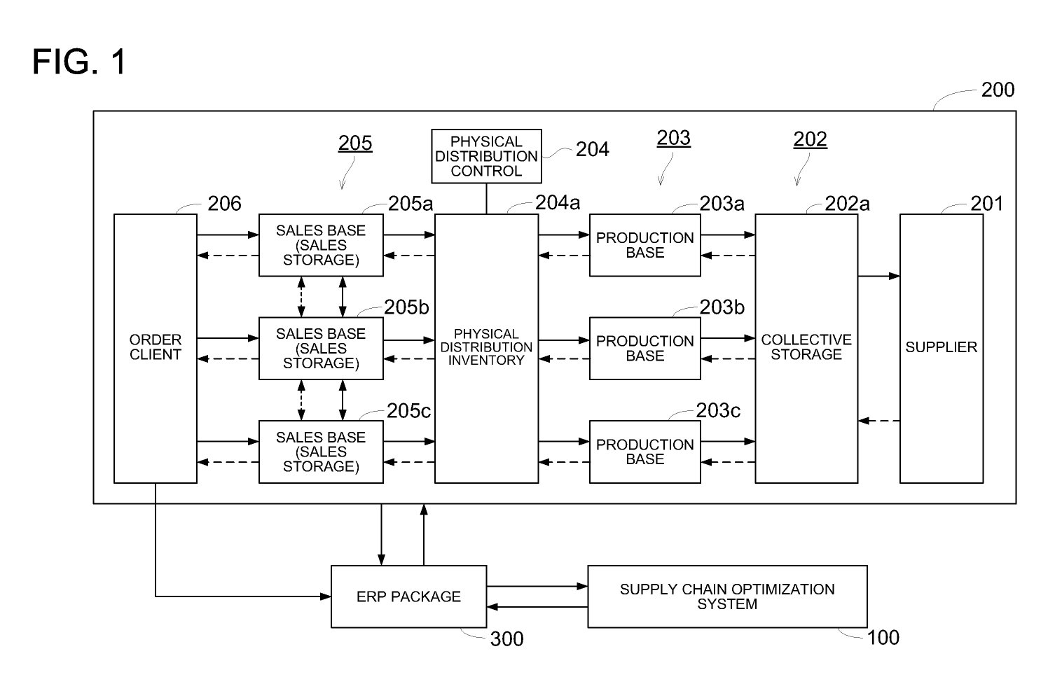

FIG. 1 shows an example of an embodiment of a supply chain and a supply chain optimization system according to the present invention.

A supply chain 200 generally includes a plurality of operation areas and made up of a series of these operation areas. In the present embodiment, the operation areas are divided as a material procurement operation area (a material procurement division), a production operation area (a production division), and a sales operation area (a sales division).

A material procurement division 202 procures materials from suppliers and manages the delivered materials. A production division 203 manages the materials in a production process, the production of products, and the products before factory shipment. A sales division 205 handles the physical distribution, the management, and the sales of the factory shipped products. Sales bases 205a to 205c in the sales division 205 are, for example, outlet dealers in the sales division of the manufacturing company producing the products and/or sales companies independent from the manufacturing company, such as a special dealer and an agent. Thus, the sales bases 205a to 205c may be apart from the sales division 205 as a separate organization.

The above divisions are not to be limited by the present embodiment; they may be appropriately set depending on the forms of material procurement and production, product specification, the forms of physical distribution and sales, and so on. In the present embodiment, the divisions are divided into three as above for explanatory purposes, but in reality, a supply chain has a more complicated structure, subdivided into many smaller divisions. The operation area often has a plurality of bases. For example, the sales division often has a plurality of sales bases. In the present embodiment, three bases are shown for each of the sales and the production divisions for explanatory purposes.

In FIG. 1, solid-line arrows show a flow of information, and broken-line arrows show a flow of goods including products and materials.

In the supply chain 200, an individual sales base receives a product order from a plurality of order clients 206. Otherwise the sale division 205 as a whole may receive orders and distribute them among the sales bases 205a to 205c. The sales division 205 places an interdivisional order to the production division 203 based on the received order. The interdivisional order may not be based on the order from the order client 206, but may be based on an expected sales plan in the sales division 205. The production division 203 selects a production base for manufacturing products from production bases (production processes) 203a to 203c, and the selected production base places a material order to each of suppliers 201.

Each supplier 201 delivers materials to a collective storage 202a provided before the production division 203. The materials are once stocked in the collective storage 202a and supplied to the production bases 203a to 203c as necessary. The products manufactured in the production bases 203a to 203c are delivered to the sales bases 205a to 205c via a physical distribution inventory 204a. The physical distribution inventory 204a includes all products in a physical distribution process between the production bases 203a to 203c and the sales bases 205a to 205c, that is, un-stored inventories being transported. The physical distribution inventory 204a is managed by a physical distribution control section 204.

In the present embodiment, the physical distribution control section 204 and the physical distribution inventory 204a are classified as an operation within the sales division 205; however, they may be separated as an independent operation division.

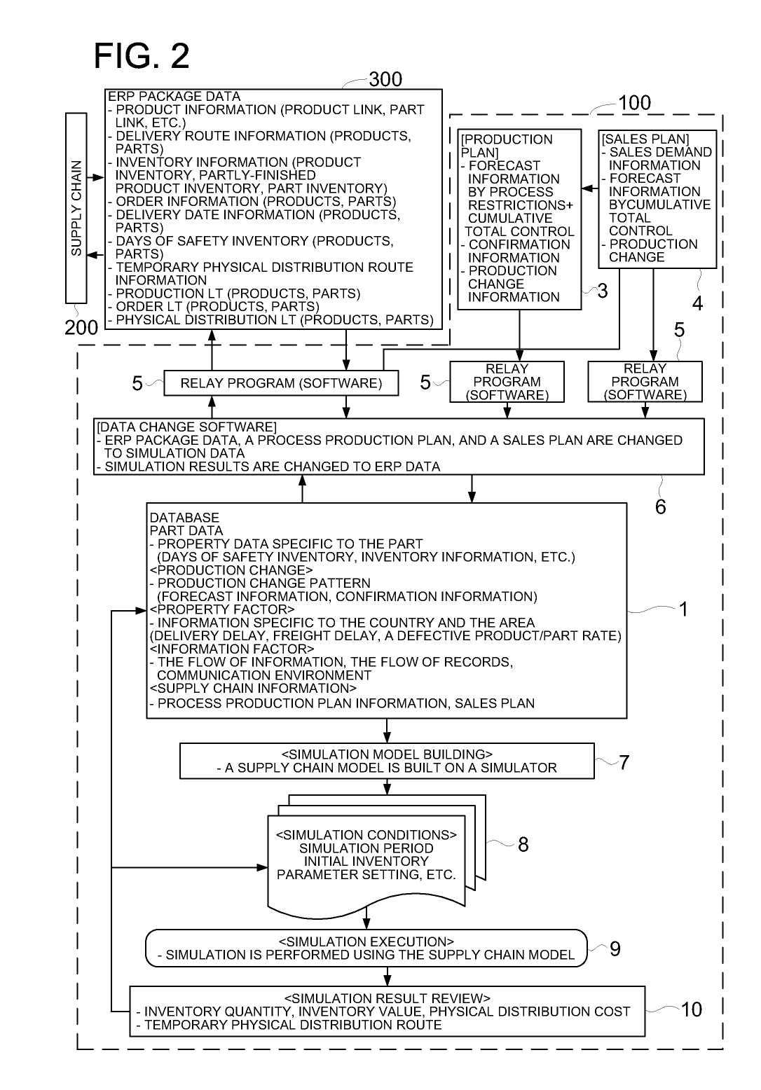

Next, a supply chain optimization system 100 according to the present invention will be described with reference to FIGS. 1 and 2.

FIG. 2 is a block diagram showing an embodiment of the supply chain optimization system (hereinafter, also referred to as the present system) 100 for optimizing a product supply chain including material procurement, production, and delivery to a client (a product destination).

In FIG. 2, a database 1 is a storage means for storing various data and information, and downloaded with ERP package 300 data and information as necessary via a relay program 5 and a data processing section 6, which is a data processing means. When the ERP package 300 is updated, the downloaded ERP package 300 data and information will be automatically updated.

The ERP package 300 is an integrated operation package having an integrated database to store product information, production information, supply chain structure data, and so on. The product information includes data on materials used for the product and their quantities, a process chart of the product, a product structure, etc. The production information includes information on the production quantity, the production lead time, and the delivery date of the product; the delivery route, the delivery lead time, the inventory, the order, the delivery date, and the price of the materials; the product inventory, etc. Note that the material inventory includes the inventory of partly-finished goods.

A sales plan creation section 4, which is a sales plan creation means, creates a sales plan based on a predetermined product need (a received order). The sales plan creation section 4 is provided within the sales division 205, for example, in a sales management division. The sales plan is sent to a production plan creation section 3.

The production plan creation section 3, which is a production plan creation means, creates a production plan based on the sales plan in consideration of each restriction in material procurement, production process, and physical distribution. The restrictions in material procurement include the production capacity of parts, a material delivery lead time, and material order agreement with the supplier. The restrictions in production process include a production lead time, the maximum production capacity of the process, and conditions for switching the production capacity of the process. The restrictions in physical distribution include a product delivery lead time, a physical distribution capacity, and the inventory capacity of storage. The production plan creation section 3 is provided within the production division 203, for example, in a production management division.

The sales plan and the production plan are inputted into the database 1 and the ERP package 300 via the relay program 5 and the data processing section 6.

In order to accommodate a production increase of products expected in the future, the sales plan creation section 4 assumes a production increase in the original sales plan, and based on a change ratio of which, a changed sales plan is prepared and sent to the production plan creation section 3. The production plan creation section 3 creates a changed production plan based on the changed sales plan and restrictions. The changed sales plan and the changed production plan are inputted into the data processing section 6. The change ratio used in the assumption may be appropriately set based on the model of the product in consideration of the expected sales of the product, market trends, and previous changes in sales plans.

The data processing section 6 creates simulation data based on the changed sales plan, the changed production plan, the product information, the production information, and the physical distribution route information. The simulation data include various data used for simulating a supply chain such as, for example, material data classified by delivery lead times, material data classified by units making up the product, a production lead time required for unit assembly of each unit, the patterns of work-in-progress units and the inventory value of the units when the units are to be stocked, the combination patterns of ordered parts and stock parts and unit stock, the production lead time and the product physical distribution lead time of the product for each combination pattern, and so on. The unit in here means a partly-finished product in which, some parts have been assembled to a predetermined level.

The variety of downloaded or created data in the data processing section 6 is inputted into the database 1.

The data processing section 6 is provided to connect with the ERP package 300, the production plan creation section 3, and the sales plan creation section 4 so that simulation data can be created using the latest information. For example, when some data in the ERP package 300 are modified due to a design change, the data processing section 6 can always create simulation data based on the latest data in the ERP package 300. Furthermore, the simulation data are created in advance so that, when a simulation is to be performed, which will be described later, the trouble of creating the simulation data is eliminated, allowing the simulation to be performed promptly.

A supply chain model is built on a computer by a model building section 7, which is a model building means, based on the data stored in the database 1 such as a supply chain structure, etc.

The supply chain model is a simulation on a computer, reproducing the actual supply chain as a virtual supply chain. The flow of goods and each process in the actual supply chain can be simulated on the computer.

In a simulation condition setting section 8, a person in charge sets simulation conditions such as a simulation period, which is, for example, how long the simulation should be continued after the occurrence of a production plan change due to a sales plan change; an initial inventory level; and various parameters such as a production quantity in a unit period.

In a simulation section 9, a simulator uses the supply chain model built as above to perform a simulation based on the simulation data and the simulation conditions. The simulation is performed based on the condition that an additional stock of products increased by a sales plan change is kept as a factory inventory, that is, an inventory in the production division 203. The simulation includes the function of an inventory calculation means for calculating a product-and-material inventory quantity to minimize the total of a product-and-material inventory value and a product-and-material physical distribution cost, and the function of a physical distribution route selection means for selecting a physical distribution route (a shipping route) for the additional stock of products from the production division 203.

In the simulation, the product-and-material inventory quantity is calculated and the physical distribution route is selected so that at the occurrence of the sales plan change, the supply chain as a whole can accommodate the sales plan change without production delay due to a material shortage or shipment delay due to a product inventory shortage while minimizing the total of the product-and-material inventory value and the product-and-material physical distribution cost. In other words, under the condition that the additional product stock increased in response to the sales plan change is kept as an inventory in the production division 203, the product-and-material inventory quantity and the physical distribution route which allow the plurality of divisions (operation areas) making up the supply chain to accommodate the sales plan change as a whole, are calculated to minimize the total of the product-and-material inventory value and the product-and-material physical distribution cost. The product inventory includes the additional product stock increased in response to the sales plan change.

In this way, the simulation reduces excess inventories caused by the redundant safety product inventories as described above, by keeping the additional product stock increased in response to the sales plan change in the inventory in the production division 203. However, when the additional product stock is kept in the inventory in the production division 203, a sales plan change in some sales bases may not be able to be fulfilled in a timely manner using an ordinary physical distribution route described above. In this case, a temporary physical distribution route such as air freight as described above may be assumed and selected.

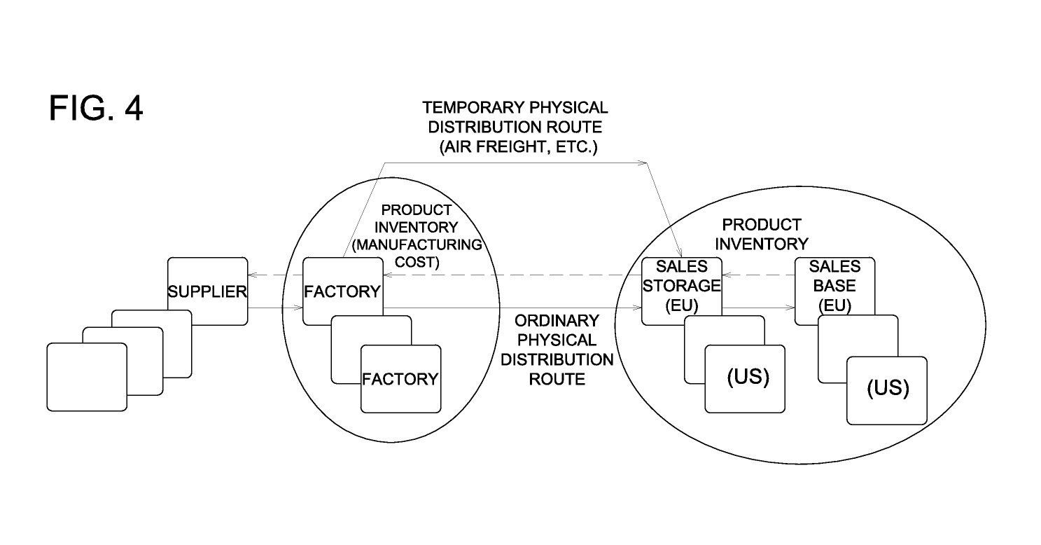

FIG. 4 shows an example in which, the additional stock is kept in the inventory in the production division 203 (factories in the figure), and a temporary physical distribution route (for example, air freight) is used for shipping the additional stock from the production division 203.

As described above, the inventory can be optimized not at each individual division level, but at the whole supply chain level to accommodate a sales plan change happened in the supply chain, and a physical distribution route can be selected at the same time to minimize the total of the inventory value and the physical distribution cost.

In particular, the additional safety stock of products which causes an increase in the inventory value is kept in the production division 203 and a sales plan change is fulfilled by changing a physical distribution route to reduce the additional inventory as a whole.

The simulation data created in the data processing section 6 are based always on the latest data in the ERP package 300, the production plan creation section 3, and the sales plan creation section 4 as described above. This allows a highly-accurate simulation which is close to the actual system.

When the simulation is performed, some data are preferably downloaded from the database 1 such as base information about bases making up the supply chain, communication environment information about the conditions of communication environment of the bases, and physical distribution information about the conditions of physical distribution of the bases. This allows even more highly-accurate simulation, which is further closer to the actual system. The base information includes, for example, the legal restrictions, the market trends, and the social environment (an operating ratio, a workforce sufficiency ratio, etc.) of the area where the base is located. The communication environment information includes the maintenance state of the communication network of the area where the base is located. The physical distribution information includes the maintenance state of the communication network related to physical distribution.

In a result evaluation section 10, a person in charge of evaluation evaluates and reviews the results of the simulation (the inventory quantity, the inventory value, and the physical distribution cost). When a further simulation is necessary under different conditions, the conditions can be reset in the simulation condition setting section 8 to preform another simulation. This allows the range of evaluation to be expanded.

The results of the simulation are fed back to the database 1 for storage, and further inputted into the ERP package 300 via the data processing section 6 and the relay program 5. The results may be inputted into the ERP package 300 from the database 1 directly through the relay program 5, skipping the data processing section 6.

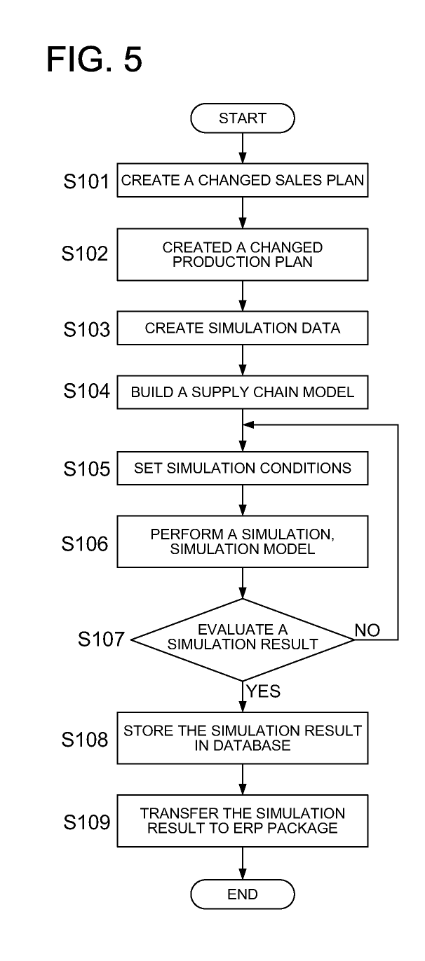

FIG. 5 shows an example of a flowchart of the supply chain optimization system shown in FIG. 2. Necessary data and information have already been downloaded into the database 1 from the ERP package 300 here.

In Step S101, the sales plan creation section 4 creates a changed sales plan using an assumed change ratio.

In Step S102, the production plan creation section 3 creates a changed production plan based on the changed sales plan created in Step S101.

In Step S103, the data conversion section 6 creates simulation data based on the changed sales plan, the changed production plan, the product information, the production information, and the physical distribution route information.

In Step S104, the model building section 7 builds a supply chain model on a computer, modeling the supply chain based on the information on the supply chain structure, etc. stored in the database 1. A plurality of supply chain models are built in combination patterns including order parts, stock parts, and product inventories, based on the simulation data created in Step S103.

In Step S105, a person in charge sets simulation conditions in the simulation condition setting section 8. The simulation conditions to be set include a simulation period, an initial inventory, and parameters such as a production quantity in a unit period.

In Step S106, the simulation section 9 performs a simulation using the supply chain model under the condition that the additional product stock increased in response to the sales plan change is kept in the inventory in a factory, that is, the production division 203. As a result of the simulation, a material-and-product inventory quantity and a physical distribution route which can accommodate the sales plan change are calculated so as to minimize the total cost of the inventory value and the physical distribution cost.

In Step S107, a person in charge of evaluation evaluates and reviews the results of the simulation (the inventory quantity, the inventory value, and the physical distribution cost) in the result evaluation section 10. When a further simulation under different conditions is necessary (Step S107: NO), the conditions are reset in Step S105 to perform another simulation. When no further simulation is necessary (Step S107: YES), the results of the simulation are stored in the database 1 in Step S108.

In Step S109, the results of the simulation are transferred from the database 1 to the ERP package 300, and reflected in the data and information in the ERP package 300.

The inventory quantity, the inventory value, and the physical distribution cost as a result of the simulation, inputted into the ERP package 300 are set as a key performance indicator (hereinafter, abbreviated as KPI) of the supply chain 200, and used as an indicator for managing the supply chain. When the supply chain 200 is in operation, the inventory quantity, the inventory value, and the physical distribution cost are measured and controlled using the KPI as an indicator. Consequently, the entire supply chain 200 can be managed and maintained at the minimum total cost of the inventory value and the physical distribution cost while preventing delay in product delivery at the occurrence of a sales plan change.

As described above, at the level of the supply chain 200 as a whole, the inventory quantity can be optimized to prevent delivery delay at the occurrence of a sales plan change, and also the total of the inventory value and the physical distribution cost can be minimized.

(A Change in Each Sales Base)

Note that in a real supply chain 200, an actual change in a sales plan (hereinafter, referred to as an actual sales plan change) happens in each individual sales base. For this reason, a physical distribution route for products in the supply chain 200 needs to be optimized in accordance with the sales plan change in each individual sales base. For example, in the supply chain 200 in FIG. 1, the sales base 205a may have a quantity increase in a sales plan having a short product delivery period, the sales base 205b may have no change in a sales plan having a long product delivery period, and the sales base 205c may have no change in a sales plan having a product delivery date between those for the sales base 205a and the sales base 205b.

Thus, in response to the sales plan change in the individual sales base, the additional product stock in the production division 203 calculated by the above simulation and the temporary physical distribution route for shipping the assumed additional stock are applied.

Alternatively, the products in the physical distribution inventory 204a which are planned to be delivered to the sales base 205b may be distributed to the sales base 205a, and the products to be additionally produced according to the production plan change (hereinafter, referred to as an actual production plan change) based on the actual sales plan change may be distributed to the sales base 205b.

As for materials, in the same manner, a physical distribution route for materials in the supply chain 200 is optimized in accordance with the actual production plan change in the production base. For example, the production base 203a may have enough production capacity but the production base 203b may not, resulting in the production base 203a to handle the additional production increased by the actual production plan change. In this case, materials in the collective storage 202 which are planned to be delivered to the production base 203b may be distributed to the production base 203a, and new materials to be delivered from the supplier 201 may be distributed to the production base 203b.

The physical distribution route here is optimized in the same way as the inventory quantity and the physical distribution route are calculated in the simulation using the supply chain model as described above by the supply chain optimization system 100 shown in FIG. 2.

Order change information from a client is sent from the order client 206 to the supply chain optimization system 100 via the ERP package 300. The order change information includes a delivery date of the products whose production is increased and information on the assigned sales base. The order change information may be sent from the assigned production base instead.

The order change information is sent to the sales plan creation section 4 via the relay program 5 in the supply chain optimization system 100.

The sales plan creation section 4 prepares an actual changed sales plan based on the order change information, and send the plan to the production plan creation section 3. The actual changed sales plan includes a changed quantity and a delivery date for each sales base. The production plan creation section 3 creates an actual changed production plan based on the actual changed sales plan and the additional stock quantity stocked in the production division 203. The actual changed sales plan and the actual changed production plan are inputted into the data processing section 6, and further inputted into the database 1 and the ERP package 300 via the relay program 5 and the data processing section 6.

The data processing section 6 creates actual simulation data based on the actual changed sales plan, the actual changed production plan, the product information, the production information, the physical distribution route information, the additional stock by the previously-described simulation, and the assumed temporary physical distribution route.

The various data downloaded or created in the data processing section 6 are inputted into the database 1.

The above-described supply chain model is used as a supply chain model.

A person in charge sets conditions for an actual simulation in the simulation condition setting section 8. In this case, the change restrictions and limitations of the physical distribution mute are set.

In the simulation section 9, the simulator, using the supply chain model, performs a simulation based on the actual simulation data and the actual simulation conditions.

Based on the simulation, a shipping quantity of the additional stock and its temporary physical distribution route, and the optimum physical distribution route, i.e., the delivery destination of the products in the physical distribution inventory 204a in the supply chain 200 at the occurrence of the actual sales plan change are selected in accordance with the actual sales plan change in each individual sales base. As for materials, in the same manner, the optimum physical distribution route (a delivery destination) for materials in the supply chain 200 is selected in accordance with the actual production plan change in the production base.

In the result evaluation section 10, a person in charge of evaluation evaluates and reviews the optimum physical distribution routes for products and materials selected by the simulation. When a further simulation is necessary under different conditions, the conditions are reset in the simulation condition setting section 8 to perform another simulation. This allows the range of evaluation to be expanded.

The optimum physical distribution routes are fed back to the database 1 for storage, and further inputted into the ERP package 300 via the data processing section 6 and the relay program 5. The data may be inputted from the database 1 into the ERP package 300 directly via the relay program 5, skipping the data processing section 6.

The optimum physical distribution routes for products and materials inputted into the ERP package 300 are applied to the supply chain 200, and the physical distribution routes for products and materials in the supply chain 200 are changed.

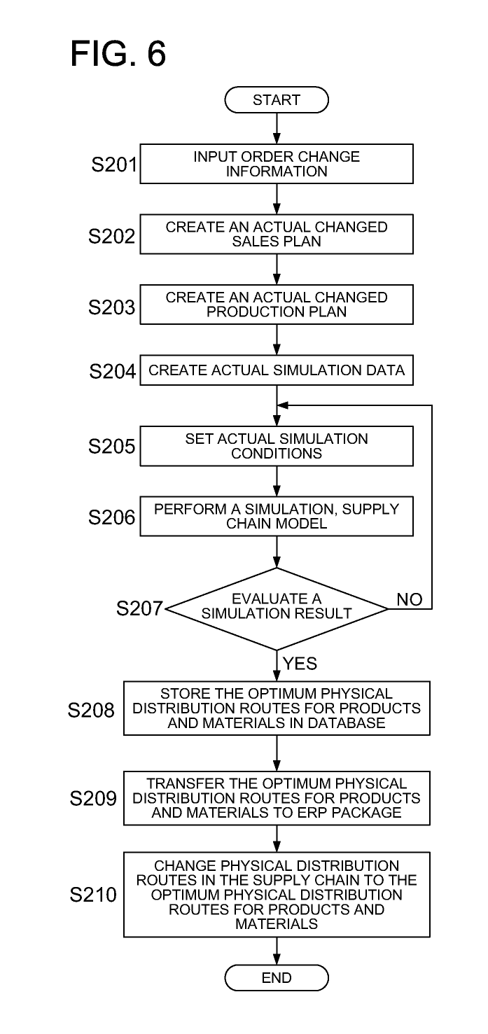

FIG. 6 is a flowchart showing the optimization of the physical distribution mutes for products and materials at the occurrence of an actual sales plan change.

In Step S201, order change information from a client is inputted.

In Step S202, the sales plan creation section 4 creates an actual changed sales plan based on the order change information.

In Step S203, the production plan creation section 3 creates an actual changed production plan based on the actual changed sales plan created in Step S202.

In Step S204, the data conversion section 6 creates actual simulation data based on the actual changed sales plan, the actual changed production plan, the product information, the production information, the physical distribution route information, the additional stock by the previously-described simulation, and the assumed temporary physical distribution route.

In Step S205, a person in charge sets actual simulation conditions in the simulation condition setting section 8. The simulation conditions to be set include the change restrictions and limitations of the physical distribution route.

In Step S206, a simulation is performed in the simulation section 9 using the supply chain model, and as a result of the simulation, a temporary physical distribution route for shipping the additional product stock stocked in the production division 203 and the optimum physical distribution route for the products in the physical distribution inventory 204a in the supply chain 200 at the occurrence of the actual sales plan change are selected in accordance with the sales plan change in each individual sales base. At the same time, the optimum physical distribution route for materials in the supply chain 200 is selected in accordance with the actual production plan change in the production base.

In Step S207, a person in charge of evaluation evaluates and reviews, in the result evaluation section 10, the optimum physical distribution routes for products and materials selected in the simulation. When a further simulation is necessary under different conditions (Step S207: NO), the conditions are reset in Step S205 for another simulation. When no further simulation is necessary (Step S207: YES), the optimum physical distribution mutes are stored in the database 1 in Step S208.

In Step 209, the optimum physical distribution routes are transferred from the database 1 to the ERP package 300, and reflected in the data and information in the ERP package 300.

In Step S210, the optimum physical distribution mutes are applied to the supply chain 200, and the physical distribution routes for products and materials in the supply chain 200 are changed.

As described above, the inventory can be optimized not at each individual division level, but at the whole supply chain level to accommodate a sales plan change happened in the supply chain and a physical distribution route can be selected at the same time to minimize the total of the inventory value and the physical distribution cost.

In particular, the additional safety stock of products, which causes an increase in the inventory value, increased in response to a sales plan change is kept in a factory and the sales plan change is fulfilled by changing a physical distribution route to minimize the additional inventory. In addition, since the additional stock is kept in the factory, the unit value of the stock is included in a factory shipment value (manufacturing cost) so that the inventory value in the whole supply chain can be reduced.

Furthermore, when a sales plan increase actually happens in the supply chain, the optimum physical distribution routes of products and materials can be promptly calculated and changed, thereby preventing delivery delay and allowing no sales chance to be lost.

### LEGEND

100 Supply chain optimization system
200 Supply chain
300 ERP package
1 Database
3 Production plan creation section
4 Sales plan creation section
5 Relay program
6 Data processing section
7 Model building section
8 Simulation condition setting section
9 Simulation section
10 Result evaluation section

1. A supply chain optimization system for optimizing a supply chain made up of a series of multiple operation areas having a plurality of bases for operations from materials procurement and product production to sales, in which materials order information is changed from expected future materials order information to materials order confirmation information, and wherein there may be a change in a production plan due to a product quantity change in a sales plan, the system comprising:
a storage section which stores data and information;
a model building section which builds a supply chain model on a computer, to model the supply chain;
a sales plan creation section which, when a product quantity is changed in a sales plan in the supply chain, creates a changed sales plan and stores the changed sales plan in the storage means section;
a production plan creation section which creates a changed production plan based on the changed sales plan and stores the changed production plan in the storage section;
a data processing section which downloads product information, production information, and physical distribution route information from an Enterprise Resource Planning (ERR) package storing the product information, the production information, and the physical distribution route information, and which downloads the changed sales plan and the changed production plan from the storage section, generates simulation data based on the product information, the production information, the physical distribution route information, the changed sales plan, and the changed production plan, and stores the data to the storage section;
an inventory calculation means section which performs a simulation in response to the sales plan change based on the stimulation data using the supply chain model, and which, under the condition that an additional product stock increased by the sales plan change is kept in a factory inventory, calculates a product-and-material inventory quantity which allows no product shortage at an occurrence of the sales plan change while minimizing a total of a product-and-material inventory value and a product-and-material physical distribution cost; and
a physical distribution route selection section which selects a physical distribution route from the factory having the additional product stock.

2. The supply chain optimization system according to claim 1, wherein the multiple operation areas include a material procurement operation area, a production operation area, and a sales operation area.

3. The supply chain optimization system according to claim 1, wherein the materials include partly-finished products.

4. The supply chain optimization system according to claim 1, wherein the product information includes data on materials used for the product, a quantity of the materials, a product flow chart, and a product structure.

5. The supply chain optimization system according to claim 1, wherein the production information includes: (i) production plan information which represents a quantity of the products and a delivery date of the products; (ii) inventory information, order information, delivery information, and price information of the materials; and (iii) product inventory information.

6. The supply chain optimization system according to claim 1, wherein the physical distribution route information includes a physical distribution lead time and a physical distribution cost of physical distribution routes for the products and the materials.

7. The supply chain optimization system according to claim 1, wherein at a time of the simulation, the simulation is performed by downloading information on the bases in the supply chain, communication environment information about a state of communication environment of the bases, and physical distribution information about a state of physical distribution of the bases, stored in the storage section.

8. A supply chain optimization method, wherein the supply chain optimization system according to claim 1 is used to calculate the product-and-material inventory quantity including the additional product stock kept in the factory inventory responding to the sales plan change, the product-and-material inventory value, and the product-and-material physical distribution cost to accommodate a sales plan change, and these values are set as a key performance indicator of the supply chain to manage the supply chain.

9. The supply chain optimization method according to claim 8, wherein, the supply chain optimization system is used to select a physical distribution route for the additional product stock to accommodate an actual product quantity change in a sales plan in the supply chain, and the physical distribution route in the supply chain is changed accordingly.
